(19) United States
(12) Patent Application Publication
(10) Pub. No.: US 2020/0073532 A1
(43) Pub. Date: Mar. 5, 2020

(54) DESIGN REVIEW DEVICE, DESIGN REVIEW METHOD, AND PROGRAM

(71) Applicant: Mitsubishi Electric Corporation, Chiyoda-ku, Tokyo (JP)

(72) Inventors: Hiroyuki SAKAI, Tokyo (JP); Takuya KANAYAMA, Tokyo (JP)

(73) Assignee: Mitsubishi Electric Corporation, Chiyoda-ku, Tokyo (JP)

(21) Appl. No.: 16/493,361

(22) PCT Filed: May 25, 2018
(86) PCT No.: PCT/JP2018/020181

§ 371 Date: Sep. 12, 2019

(30) Foreign Application Priority Data
May 25, 2017 (JP) 2017-103675

(51) Int. Cl. G06F 3/0481; G06F 17/50; G06F 3/0354; G06F 3/0484; G06F 3/0485; G06K 9/22; G06K 9/00; G06T 7/70; G06F 3/01

(52) U.S. Cl. CPC G06F 3/04815; G06F 17/50; G06F 3/03545; G06F 3/04845; G06F 3/0485; G06F 2217/02; G06K 9/00402; G06T 7/70; G06F 3/014; G06F 3/017; G06K 9/222

(57) ABSTRACT

A design review device includes a communicator, a display controller, and a capturer. The communicator accesses a data server storing data for a 3D model of a component included in a product, data for a 3D model of a tool to be used in assembling the product, and data for a review sheet including a design review result for the product. The display controller displays a screen for selecting at least one of the 3D model of the component or the 3D model of the tool in a virtual space. The capturer detects a user action and selects, in response to the user action, at least one of the 3D model of the component or the 3D model of the tool displayed in the virtual space.

### TECHNICAL FIELD

The present disclosure relates to a design review device, a design review method, and a design review program.

### BACKGROUND ART

Design review is performed to determine whether a product can actually be manufactured and to review the design and the manufacturing processes of the product. A known device for performing design review may be a design review device that includes a head mount display (hereafter, HMD) for displaying a three-dimensional (3D) model of a product projected in a virtual space and an operator for operating the 3D model displayed in the virtual space.

Patent Literature 1 describes one example of such a design review device including an HMD that may display virtual design elements in a manner superimposed on a shoe model placed in a real environment to determine whether the shoe can be manufactured.

### CITATION LIST

### Patent Literature

Patent Literature 1: Unexamined Japanese Patent Application Kokai Publication No. 2016-189213

### SUMMARY OF INVENTION

### Technical Problem

At design review, a user wearing a non-transmissive HMD cannot easily view the real space directly and cannot easily operate an input terminal. A user wearing a semi-transmissive HMD also cannot easily operate an input terminal when the display from the HMD is superimposed on the input terminal. Another operator thus operates the input terminal. The design review involves many operators and is inefficient.

One or more aspects of the present disclosure are directed to a design review device, a design review method, and a design review program that allow efficient design review.

### Solution to Problem

To achieve the above object, a design review device according to the present disclosure includes a communicator to access a data server storing data for a 3D model of a component included in a product, data for a 3D model of a tool to be used in assembling the product, and data for a review sheet including a design review result for the product, a display controller to display in a virtual space a screen for selecting at least one of the 3D model of the component or the 3D model of the tool, and a capturer to detect a user action and select, in response to the user action, the at least one of the 3D model of the component or the 3D model of the tool displayed in the virtual space.

### Advantageous Effects of Invention

The above aspect of the present disclosure allows efficient design review by detecting a user action and selecting, in response to the user action, at least one of a 3D model of a component or a 3D model of a tool displayed in a virtual space.

### BRIEF DESCRIPTION OF DRAWINGS

FIG. 1 is a block diagram of a design review device according to an embodiment of the present disclosure;

FIG. 2A is a table showing data stored in a product model database (DB) according to the embodiment of the present disclosure;

FIG. 2B is a table showing data stored in a tool model DB according to the embodiment of the present disclosure;

FIG. 2C is a table showing data stored in a review sheet DB according to the embodiment of the present disclosure;

FIG. 2D is a table showing data stored in a component model DB according to the embodiment of the present disclosure;

FIG. 2E is a table showing data stored in a review model DB according to the embodiment of the present disclosure;

FIG. 3 is a diagram showing a tool according to the embodiment of the present disclosure;

FIG. 4 is a diagram showing a reference board and a stylus capture device according to the embodiment of the present disclosure;

FIG. 5 is a diagram showing a menu screen according to the embodiment of the present disclosure;

FIG. 6 is a diagram showing a 3D model and a product name displayed in a scrollable manner according to the embodiment of the present disclosure;

FIG. 7A is a diagram showing a 3D model and a component name of a component displayed in a scrollable manner according to the embodiment of the present disclosure;

FIG. 7B is a table showing design information for a component according to the embodiment of the present disclosure;

FIG. 8 is a diagram showing a 3D model and a tool name displayed in a scrollable manner according to the embodiment of the present disclosure;

FIG. 9 is a flowchart showing a design review process according to the embodiment of the present disclosure;

FIG. 10 is a flowchart showing a review result recording process according to the embodiment of the present disclosure;

FIG. 11 is a diagram showing a design review target displayed in a virtual space according to the embodiment of the present disclosure;

FIG. 12 is a table showing a format of a review sheet displayed in a virtual space according to the embodiment of the present disclosure;

FIG. 13 is a table showing a review sheet including a review result displayed in a virtual space according to the embodiment of the present disclosure;

FIG. 14 is a table showing a review sheet including a review result according to the embodiment of the present disclosure;

FIG. 15 is a block diagram showing a design review device according to Embodiment 2 of the present disclosure;

FIG. 16A is a table showing data stored in a personnel information DB according to Embodiment 2 of the present disclosure;

FIG. 16B is a table showing data stored in a facility information DB according to Embodiment 2 of the present disclosure; and

FIG. 16C is a table showing data stored in a customer spec information DB according to Embodiment 2 of the present disclosure.

### DESCRIPTION OF EMBODIMENTS

### Embodiment 1

A design review device according to one or more embodiments of the present disclosure will now be described with reference to the drawings.

A design review device 100 according to the present embodiment is used for design review for an installation method used in planning and designing the specifications of products including an elevator. The purpose of the design review is to verify whether the assembly work can be actually performed or can be safely performed. In the example described below, the design review device 100 is used to verify whether a sufficient space is provided for the installation work for tightening bolts with a tool or the tool can interfere with other components.

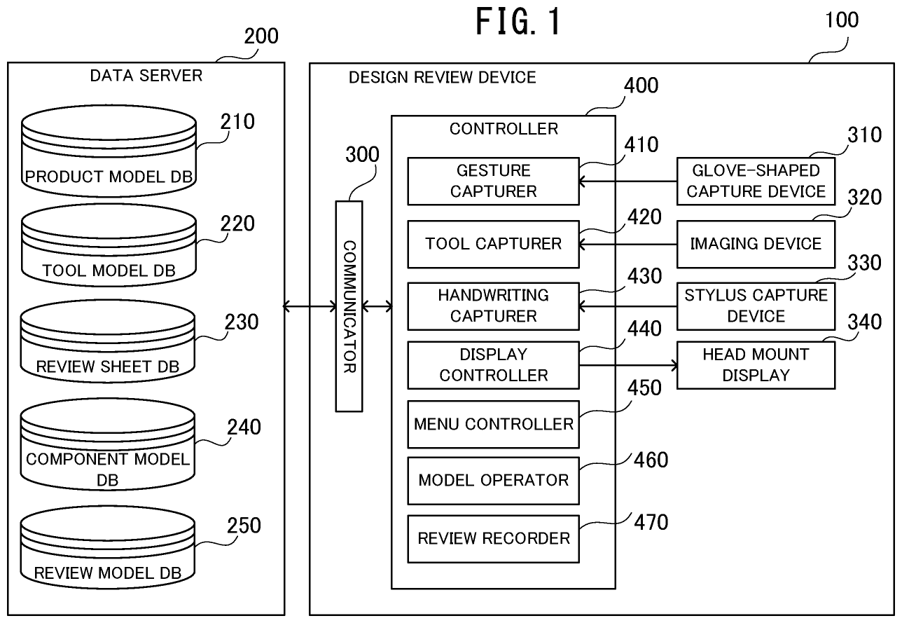

As shown in FIG. 1, the design review device 100 includes a communicator 300 that accesses a data server 200 storing three-dimensional (3D) model data for design review, a glove-shaped capture device 310 that detects the motions of a user's hand and digits, an imaging device 320 that captures an image of the motion of a tool, a stylus capture device 330 that detects handwriting, a head mount display (HMD) 340 that displays a 3D virtual space, and a controller 400 that performs a design review process.

The data server 200 includes a hard disk drive (HDD) for storing data. The data server 200 stores a product model database (DB) 210 storing data about products, a tool model DB 220 storing data about tools, a review sheet DB 230 storing data about review sheets, a component model DB 240 storing data about components, and a review model DB 250 storing data about combinations of products for which design review has been performed previously, and associated tools and review sheets.

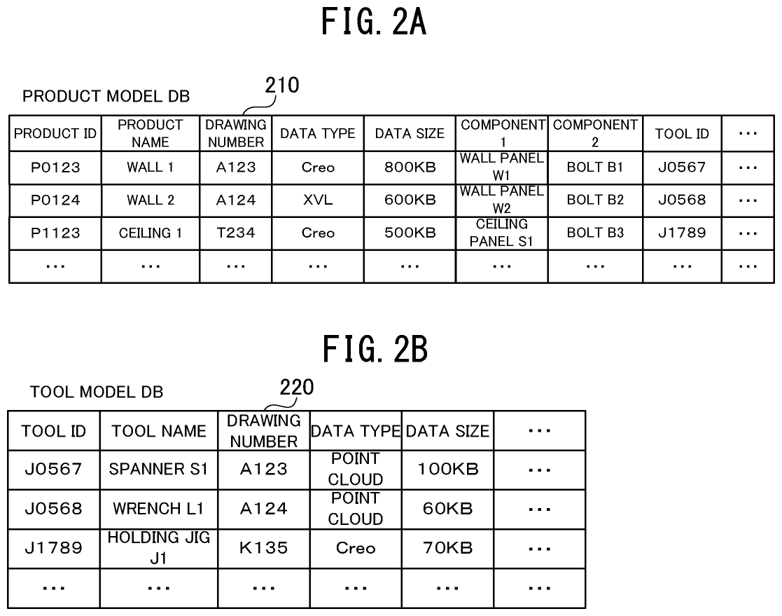

As shown in FIG. 2A, the product model DB 210 stores, in a manner associated with one another, product identifications (IDs) representing products to undergo design review, product name data representing the names of the products, data representing drawing numbers, 3D model data for products associated with the drawing numbers, typical drawings showing products associated with the drawing numbers, data types, data sizes, component name data for components included in a product, and tool IDs for tools used in the assembly. The 3D model data for products includes 3D model data for the product created by a 3D computer-aided design (CAD) system. The typical drawing showing a product includes a front view or a perspective view of the product. In this example, products include a wall and a ceiling used for an elevator. The product model DB 210 associates product IDs with tool IDs stored in the tool model DB 220. For each product model, tool candidates to be used are selected automatically based on the associated product IDs and tool IDs. The selected tool models are displayed on the HMD 340. A reviewer can then select a tool to be used for the assembly from the displayed candidates.

As shown in FIG. 2B, the tool model DB 220 stores, in a manner associated with one another, tool IDs for tools to be used in assembling a product, name data representing the names of the tools, drawing numbers for the tools, 3D model data for the tools associated with the drawing numbers, typical drawings showing tools associated with the drawing numbers, data types, and data sizes. The 3D model data for a tool may be 3D model data obtained by scanning the tool with a 3D scanner or 3D model data for the tool created with a 3D CAD system. The typical drawing showing a tool includes a front view or a perspective view of the tool.

As shown in FIG. 2C, the review sheet DB 230 stores, in a manner associated with one another, header information representing the titles of review sheets including design review results, review sheet IDs for the review sheets, customer IDs, review item names representing individual review tasks performed in design review, design review results, reviewers who have performed design review, the dates of design review, data including languages used in the review sheets, and data written in the remarks field. The review sheet DB 230 stores the format of a review sheet that is yet to contain any review result. In this example, the review items include whether a sufficient space is provided for an installation process for tightening bolts with a tool or the tool can interfere with other components. After design review is performed, a review sheet including a review result is stored into the review sheet DB 230.

As shown in FIG. 2D, the component model DB 240 stores, in a manner associated with one another, component IDs for components included in a product, component names representing the names of the components, drawing numbers for the components, 3D models of the components associated with the drawing numbers, typical drawings showing components associated with component IDs, sizes of components, and materials of components. The 3D model data for components may be 3D model data obtained by scanning the component with a 3D scanner or 3D model data for the component created with a 3D CAD system.

As shown in FIG. 2E, the review model DB 250 stores, in a manner associated with one another for each product, review model IDs representing review models, stored product models, tool models, and review sheets. To review a product that has been reviewed previously, data for the product stored in the review model DB 250 may be called to collectively call the product, the tool, and the review sheet.

The communicator 300 shown in FIG. 1 accesses the data server 200 through a communication line to call data stored in the data server 200 and transmit data to the data server 200. The communication line may be any line that enables access to the data server 200, and may be an internal bus installed inside the design review device 100 to enable access to the data server 200 or an Internet line installed externally to enable access to the data server 200. The communicator 300 outputs data about the product models, tool models, component models, and review sheets called from the data server 200 to the controller 400. The communicator 300 transmits the data about the design review output from the controller 400 to the data server 200.

The glove-shaped capture device 310 in the shape of a glove includes a sensor for detecting the position and the orientation of a hand and a sensor for detecting whether each digit is extended or bent. The glove-shaped capture device 310 detects the position of a hand and the motion of each digit of a user wearing the device, and outputs a signal representing the position and the orientation of the hand and the motion of each digit to the controller 400.

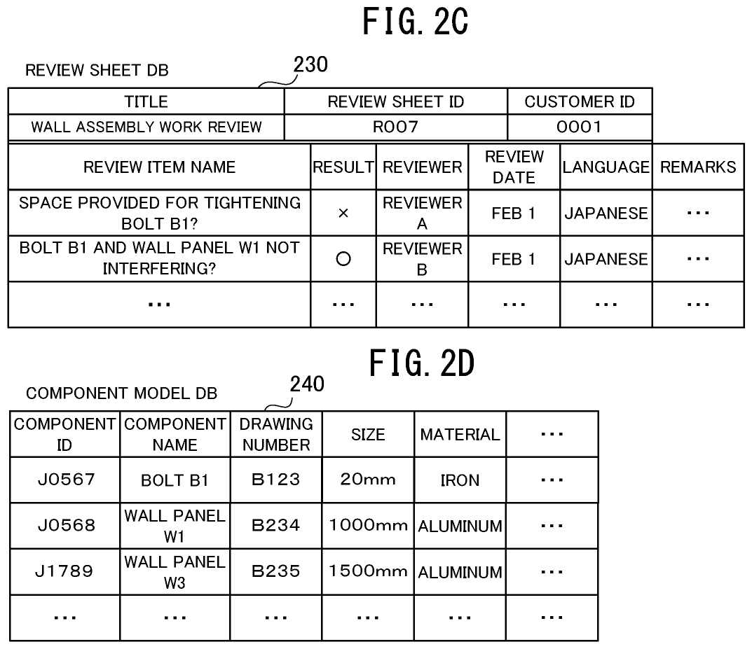

The imaging device 320 captures an image of a target reference marker on a tool to detect the position and the orientation of the tool, and outputs data representing this image to the controller 400. In this example, the imaging device 320 captures an image of a target reference marker 351 on a spanner 350 as a tool shown in FIG. 3, and outputs data representing the image to the controller 400. The spanner 350 is a tool used for assembling a product, and may either be a real tool or a dummy tool. The tool model DB 220 stores a 3D model of a spanner as a tool corresponding to the spanner 350.

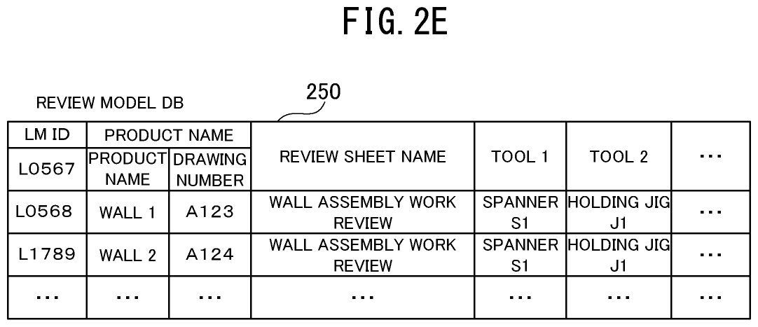

To detect handwriting, the stylus capture device 330 includes an acceleration sensor 331 that detects the motion and the inclination of a stylus, and a pressing force sensor 333 that detects a force applied to the tip of the stylus pressed onto a reference board 332 as shown in FIG. 4. The stylus capture device 330 outputs data detected with the acceleration sensor 331 and the pressing force sensor 333 to the controller 400. The reference board 332 includes a touchscreen sensor. The reference board 332 detects a location pressed by the stylus capture device 330 and outputs data representing the detected location to the controller 400.

The HMD 340 is a display device worn on a head. The HMD 340 includes a right display for displaying an image viewed by a right eye, a left display for displaying an image viewed by a left eye, and a sensor for detecting the position and the orientation of the head. The HMD 340 is a non-transmissive display device. A user wearing the HMD 340 cannot directly view the real space. As controlled by the controller 400, the right display displays a virtual space image viewed by a right eye, and the left display displays a virtual space image viewed by a left eye to display the 3D image in a virtual space. The HMD 340 displays a 3D virtual space corresponding to the position and the orientation of the head of the user wearing the HMD 340.

The controller 400 shown in FIG. 1 includes a central processing unit (CPU), a read only memory (ROM), and a random access memory (RAM). Through the processing performed by the CPU to read a program stored in the ROM and execute the program on the RAM, the controller 400 functions as a gesture capturer 410 that captures the motions of a user's hand and digits, a tool capturer 420 that captures the position and the orientation of a tool placed in the real space, a handwriting capturer 430 that reads handwriting written with the stylus capture device 330, a display controller 440 that controls images displayed on the HMD 340, a menu controller 450 that calls data for design review, a model operator 460 that moves and rotates a 3D model displayed in the virtual space, and a review recorder 470 that stores a review result into the review sheet DB 230.

The gesture capturer 410 analyzes a signal output from the glove-shaped capture device 310, captures the position and the orientation of a user's hand and the motion of each digit by integrating twice the acceleration of the hand representing the motion of the user's hand, and stores the captured data into the RAM. The motion of each digit includes the extending or bending motion of each digit. In this example, the gesture capturer 410 recognizes a motion of bending a forefinger as an action of clicking, and a motion of extending a forefinger and a middle finger and moving these fingers horizontally as an action of scrolling.

The tool capturer 420 obtains an image of a tool with a target reference marker captured by the imaging device 320, and stores the obtained image into the RAM. The tool capturer 420 analyzes the image to capture the position and the orientation of the tool. In this example, the tool capturer 420 obtains an image of the spanner 350 with the target reference marker 351 shown in FIG. 3, stores the image into the RAM, and analyzes the image to capture the position and the orientation of the spanner 350 as the tool.

The handwriting capturer 430 shown in FIG. 1 analyzes signals output from the stylus capture device 330 and the reference board 332 to capture the location of writing on the reference board 332 and the handwriting written with the stylus capture device 330, and stores the obtained data into the RAM.

The display controller 440 controls images displayed in a 3D virtual space on the HMD 340 that is worn by the user. The image includes a 3D model of a product, a 3D model of a tool, a 3D model of a component (or 3D models of components), and a format of a review sheet. The 3D model of the tool is displayed to be superimposed on the tool placed in the real space. The format of a review sheet is displayed to be superimposed on the reference board 332.

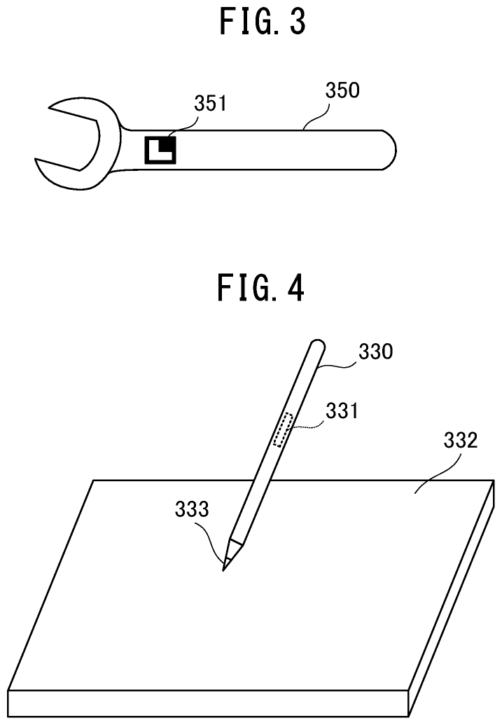

The menu controller 450 calls and selects data from the product model DB 210, the tool model DB 220, the review sheet DB 230, and the component model DB 240, and edits the data. The menu controller 450 displays a menu screen shown in FIG. 5 in a virtual space through the HMD 340 in response to an instruction for starting a design review process. The menu screen is displayed in the virtual space during the design review process. The menu screen includes “Select product model,” “Select tool,” “Select review sheet,” and “Display details.”

The menu controller 450 shown in FIG. 1 performs processing for selecting a product model, a tool model, or a review sheet in response to a gesture by the user wearing the glove-shaped capture device 310 or to handwriting written with the stylus capture device 330.

The processing performed by the menu controller 450 will now be described.

(1) Selecting a product model

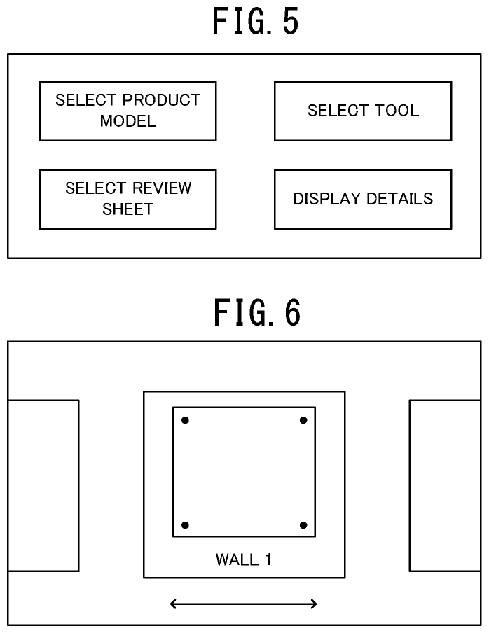

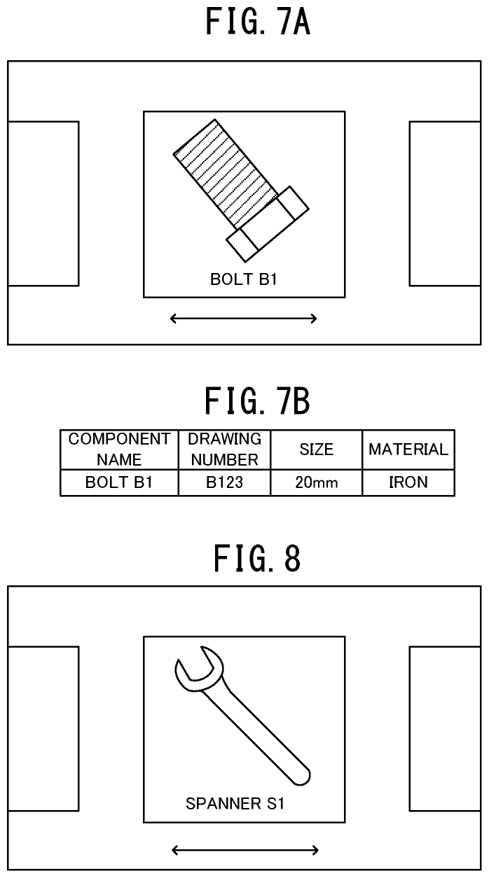

In response to the user's gesture of clicking “Select product model” displayed on the menu screen, the menu controller 450 calls typical drawings showing products and the product names from the product model DB 210. The menu controller 450 then lists typical drawings showing products and the product names in the virtual space in a scrollable manner as shown in FIG. 6. The menu controller 450 scrolls the typical drawings showing products and the product names displayed in the virtual space in response to the user action of instructing scrolling. In response to the user action of clicking to select a target product, the menu controller 450 selects the designated product. When the product is selected, the menu controller 450 displays typical drawings for components included in the designated product and the component names in the virtual space in a scrollable manner as shown in FIG. 7A.

(2) Selecting a Component

The menu controller 450 scrolls the typical drawings for the components and the component names displayed in the virtual space in response to the user action of instructing scrolling. In response to the user action of clicking to select a target component to be reviewed, the menu controller 450 selects the designated component. When the user clicks “Display details” shown in FIG. 5, the menu controller 450 refers to the component model DB 240 to display selected design information including the component name, the drawing number, the size, and the material shown in FIG. 7B.

(3) Selecting a Tool Model

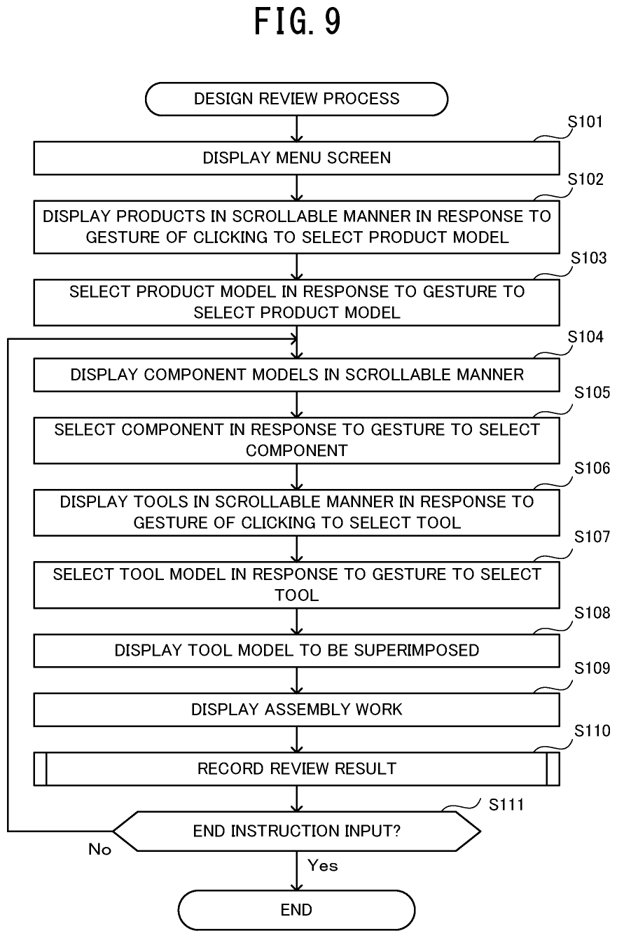

In response to an action of clicking “Select tool” on the menu screen shown in FIG. 5, the menu controller 450 calls candidate tools from the tool model DB 220, and lists the typical drawings for the tools and the tool names shown in FIG. 8 in the virtual space in a scrollable manner. After a target tool is selected and a target associated button (not shown) is clicked, the menu controller 450 performs assignment and the display controller 440 displays the 3D model of the tool on the HMD 340 to be superimposed on the tool placed in the real space captured by the tool capturer 420.

(4) Selecting a Review Sheet

In response to the user action of clicking “Select review sheet” on the menu screen shown in FIG. 5, the menu controller 450 calls review sheet formats from the review sheet DB 230 and displays the review sheet formats to be superimposed on the reference board 332. A review sheet format is selected based on a name that is input as text data obtained by converting handwriting input with the stylus capture device 330. When the design review has been performed previously, the review sheet recorded in the previous design review is called from the review sheet DB 230.

The model operator 460 moves and rotates a 3D model of a component displayed in the virtual space within the range of no contact with 3D models of tools and 3D models of other components in response to a gesture of the user wearing the glove-shaped capture device 310. When the user moves his or her forefinger touching a 3D model of a component vertically and horizontally, the model operator 460 rotates the 3D model of the component displayed in the virtual space. When the user pinches a model with his or her forefinger and thumb, the model is selected as a target to be moved. When the user moves his or her hand pinching the model, the model operator 460 moves the 3D model of the component. When the user clicks a part of a 3D model of a component with his or her middle finger, the display state of the part is switched from hidden to displayed or from displayed to hidden.

The model operator 460 moves and rotates a 3D model of a tool displayed in the virtual space within the range of no contact with 3D models of other tools and 3D models of components in accordance with the position and the orientation of a tool placed in the real space and captured by the imaging device 320.

When the user manipulates a tool placed in the real space to assemble a 3D model of a component with the 3D model of the tool displayed in the virtual space, the model operator 460 moves and rotates the 3D model of the component displayed in the virtual space in response to the user action. When the 3D model of the component comes in contact with the 3D model of other components during the assembly, the model operator 460 determines a failure in the assembly due to interference between the component and another component, and reports an error. When a space in which the 3D model of the tool is moved is at a reference level or lower to cause contact with the 3D model of the component during the assembly, the model operator 460 determines that an insufficient space is provided for using the tool, and reports an error. In this example, the model operator 460 determines that an insufficient space is provided for using the tool and reports an error when the angle at which the spanner 350 as the tool is movable is less than a reference angle.

The review recorder 470 stores a review result written by the user using the stylus capture device 330 into the review sheet DB 230. The review recorder 470 determines the position at which writing has been performed with the stylus capture device 330 on a review sheet displayed to be superimposed on the reference board 332 through the touchscreen sensor included in the reference board 332, and detects the position at which the user has input a review result using the stylus capture device 330 on the review sheet. The review recorder 470 determines the language used for handwriting through pattern recognition of the handwriting captured with the stylus capture device 330, and converts the handwriting data to text data. More specifically, the language is determined through pattern recognition based on whether the handwriting pattern represents alphabetical characters, characters including kanji and hiragana, or only kanji characters. When the handwriting represents alphabetical characters, a specific language is determined based on the spelling. The review recorder 470 stores the language of the text input with the stylus capture device 330 and the review sheet including the text data into the review sheet DB 230.

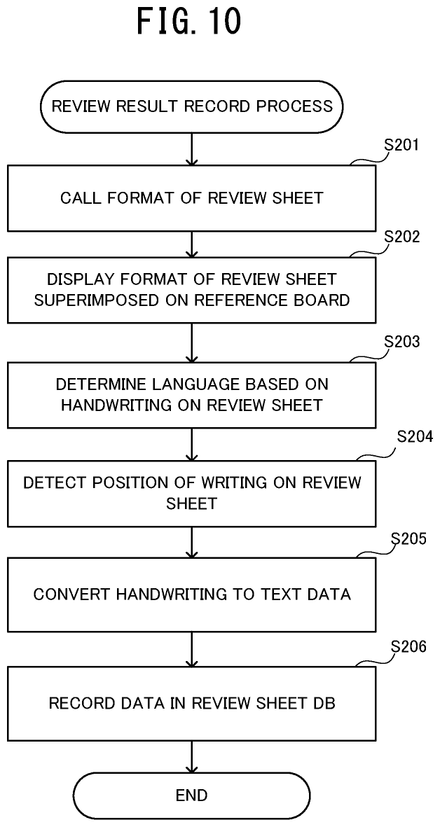

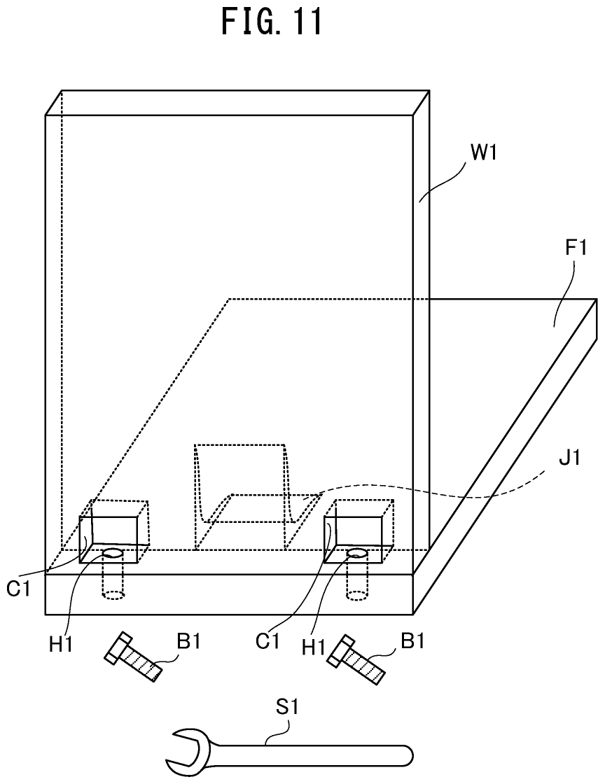

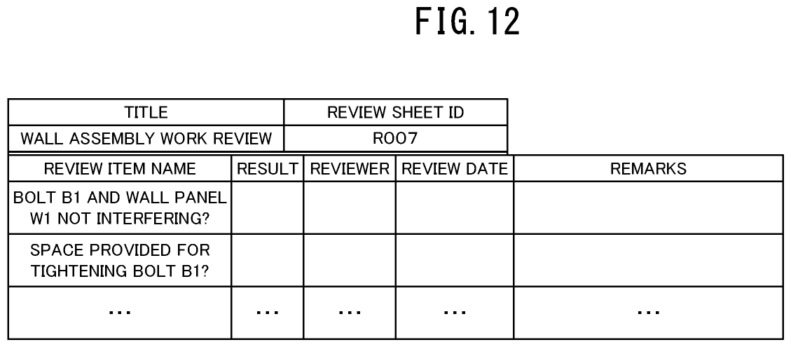

The design review process performed by the design review device 100 according to the present embodiment will now be described with reference to the flowcharts shown in FIGS. 9 and 10. The design review described below reviews an installation process for installing a wall panel W1 of an elevator shown in FIG. 11 onto a floorboard F1.

The user wears the HMD 340 on the head and the glove-shaped capture device 310 on the hand. In response to an instruction for starting the design review process, the design review device 100 starts the design review process shown in FIG. 9.

When the design review process starts, the design review device 100 displays the menu screen shown in FIG. 5 in the virtual space through the HMD 340 (step S101). The menu screen includes the items “Select product model”, “Select tool”, “Select review sheet”, and “Display details”. When a gesture of clicking “Select product model” is detected, the menu controller 450 displays typical drawings for products and the product names shown in FIG. 6 in the virtual space in a scrollable manner (step S102). When the typical drawings for the products and the product names are scrolled and a gesture of clicking to select a product model of a target product is detected, the menu controller 450 selects the product from the product model DB 210 (step S103).

When the product is selected, the menu controller 450 displays typical drawings for component models included in the product and the component names shown in FIG. 7A in the virtual space in a scrollable manner (step S104). When the typical drawings for the components and the component names displayed in the virtual space are scrolled and a gesture of clicking to select a target component is detected, the menu controller 450 selects the clicked component (step S105). The 3D model of the selected component is displayed in the virtual space. In this example, the wall panel W1 to be installed on the floorboard F1 of the elevator and a bolt B1 are selected.

When a gesture of clicking “Select tool” shown in FIG. 5 is detected, the menu controller 450 displays typical drawings for tools and tool names shown in FIG. 8 in the virtual space in a scrollable manner (step S106). When the typical drawings for the tools and the tool names are scrolled and a gesture of clicking to select a target tool is detected, the menu controller 450 selects the tool (step S107). In this example, a holding jig J1 and a spanner S1 are selected as tools. The holding jig J1 holds the wall panel W1 at a predetermined position until the wall panel W1 is installed. After the target tool is selected and a target associated button (not shown) is then clicked, the menu controller 450 performs assignment, and the display controller 440 displays the 3D model of the tool to be superimposed on the tool placed in the real space (step S108). More specifically, the tool capturer 420 analyzes the image of a target reference marker on the tool, and detects the position and the orientation of the tool. Based on the position and the orientation of the tool, the display controller 440 displays the 3D model of the tool to be superimposed on the tool placed in the real space.

As shown in FIG. 11, the model operator 460 detects the user's assembly work using gestures, and then displays the assembly work for installing the wall panel W1 and the bolt B1 that are components displayed in the virtual space at a predetermined position on the floorboard F1 with the spanner S1 as a tool (step S109). In this example, the floorboard F1 is displayed in the virtual space in advance. When the user's gesture is detected, the model operator 460 moves the wall panel W1 displayed in the virtual space to the predetermined position on the floorboard F1. When the user action of moving the holding jig J1 placed in the real space is detected, the model operator 460 moves the holding jig J1 displayed in the virtual space. In response to the user action of moving the holding jig J1, the model operator 460 moves the holding jig J1 displayed in the virtual space to a position for holding the wall panel W1. When the user's gesture is detected, the model operator 460 then moves the bolt B1 displayed in the virtual space to a threaded hole H1 in a recess C1 on the wall panel W1. When the user's gesture of screwing the bolt B1 is detected, the bolt B1 is temporarily tightened into the threaded hole H1 displayed in the virtual space. When an action of tightening the bolt B1 with the spanner 350 placed in the real space is detected, the model operator 460 finally tightens the bolt B1 with the spanner S1 displayed in the virtual space. The spanner S1 in this example may be movable within the range with no contact with the recess C1. When an angle for moving the spanner S1 is less than a reference angle, the model operator 460 determines that an insufficient space is provided for the tool, and reports an error. In this example, the spanner S1 cannot be moved by the reference angle or more, and thus an error is reported.

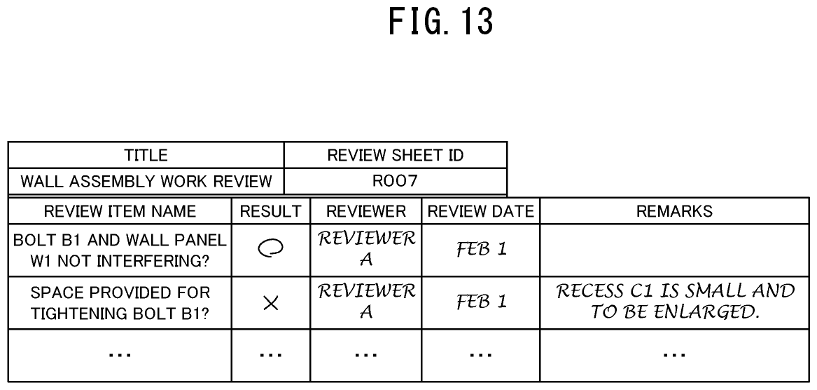

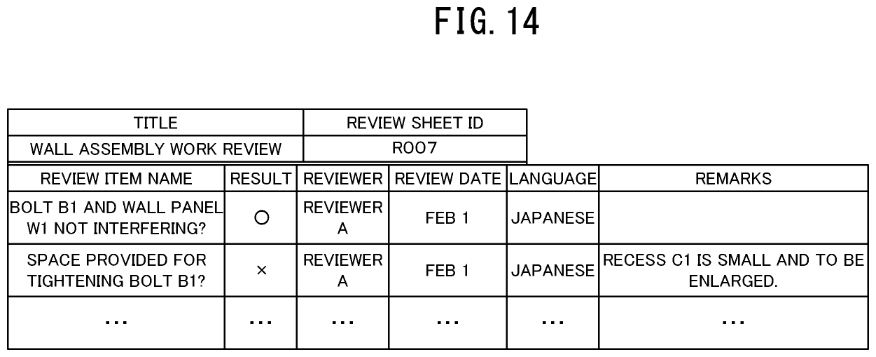

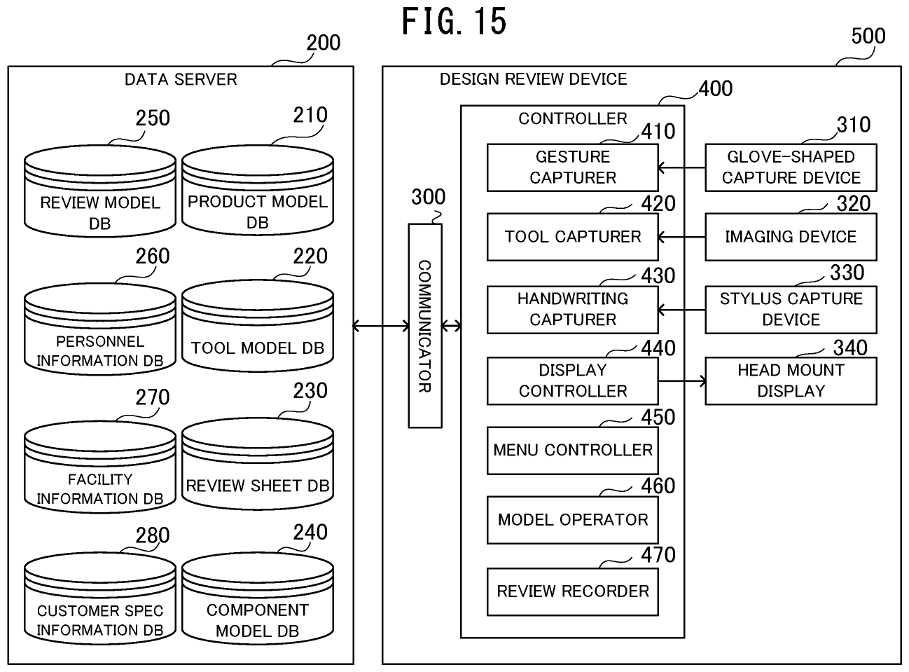

A review result record process is then started (step S110). When “Select review sheet” is clicked on the menu screen shown in FIG. 5, the menu controller 450 calls a format of a review sheet shown in FIG. 12 from the review sheet DB 230 as shown in FIG. 10 (step S201). The display controller 440 then displays the format of the review sheet to be superimposed on the reference board 332 (step S202). When the review sheet is displayed, the user writes a review result, a reviewer, and a review date with the stylus capture device 330 as shown in FIG. 13. In this example, the bolt B1 is temporarily tightened, and thus the review item “Bolt B1 and wall panel W1 not interfering?” is passed and marked with a circle. Also, the spanner S1 cannot be moved by the reference angle or more. The review item “Space provided for tightening bolt B1?” is thus marked with a cross indicating a failure. The user writes the reason of the failure or improvements in the remarks field of the review sheet. In this example, a message “Recess C1 is small and to be enlarged.” is then written in the remarks field. When the user has written a review result in the format of the review sheet with the stylus capture device 330, the review recorder 470 determines the language based on the handwriting captured with the stylus capture device 330 (step S203). The review recorder 470 then determines the location of the writing in the format of the review sheet displayed to be superimposed on the reference board 332, and detects the position at which the review result has been input in the format of the review sheet (step S204). The review recorder 470 then converts the handwriting input with the stylus capture device 330 to text data as shown in FIG. 14 (step S205). The review recorder 470 then stores the review sheet including the language of the text and the text data input in the fields corresponding to the detected position into the review sheet DB 230 (step S206).

The processing then returns to the design review process shown in FIG. 9 to determine whether an end instruction is input (step S111). When the determination indicates that an end instruction has not been input (No in step S111), the processing in steps S104 to S111 is repeated until an end instruction is input. When an end instruction has been input (Yes in step S111), the design review process ends.

The design review device 100 with the above structure allows easy selection of a product, a component, and a tool through the user's gesture of scrolling and clicking a 3D model displayed in a scrollable manner. Additionally, a review result is recorded using text data obtained by converting handwriting input with the stylus capture device 330. This structure allows the user wearing the HMD 340 to easily operate the design review device 100 and efficiently perform design review. The language used in the review sheet can be determined to identify the country in which the design review has been performed.

### Embodiment 2

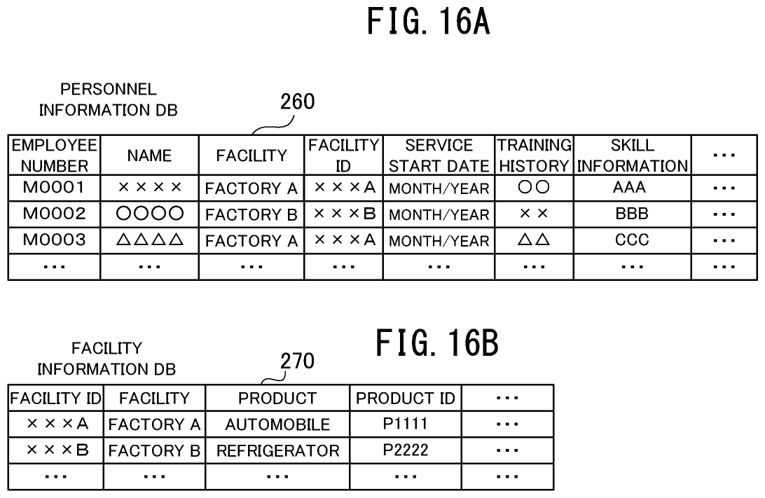

As shown in FIG. 15, a design review device 500 according to Embodiment 2 differs from the design review device 100 according to Embodiment 1 in that the data server 200 further includes a personnel information DB 260 for storing information about reviewers, a facility information DB 270 for storing information about manufacturing facilities, and a customer spec information DB 280 for storing information about customers.

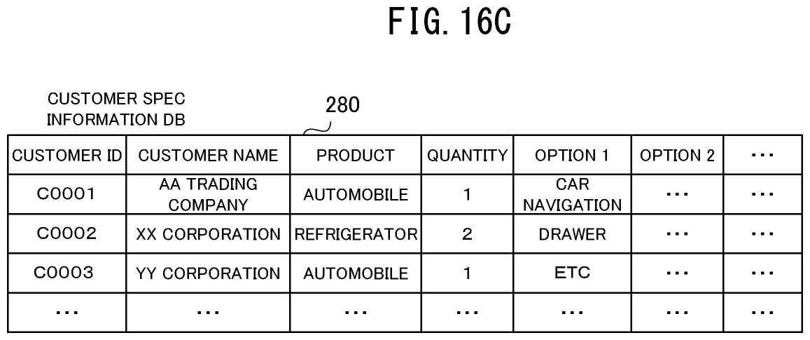

As shown in FIG. 16A, the personnel information DB 260 stores, in a manner associated with one another for each reviewer, employee numbers, names, facilities to which each reviewer belongs, service start dates, training histories, facility IDs, and skill information. To perform the design review process, the design review device 500 may call the data stored in the personnel information DB 260 to collectively call the employee number, the name, the facility, the service start date, the training history, and the skill information.

As shown in FIG. 16B, the facility information DB 270 stores facilities, products, and product IDs in a manner associated with one another for each facility ID. To perform the design review process, the design review device 500 may call the data stored in the facility information DB 270 to selectively call products for each facility.

As shown in FIG. 16C, the customer spec information DB 280 stores, in a manner associated with one another for each customer ID, customer names, products, quantities, options 1, and options 2. To perform the design review process, the design review device 500 may call the data stored in the customer spec information DB 280, and then use the called data as reference information for the design review process.

The design review device 500 uses the service start date, the training history, and the skill information for each reviewer stored in the personnel information DB 260 and displays different review sheets for each reviewer depending on the skill, the learning level, and the experience. For example, the review sheet DB 230 stores a review sheet A describing a review procedure in detail with pictures and a review sheet B briefly describing a review procedure. Based on the learning level determined from the reviewer's years of experience, the HMD 340 displays the review sheet B for experienced reviewers who have experienced design review for at least a predetermined number of years and the review sheet A for beginners who have experienced design review for less than the predetermined number of years. The reviewer's years of experience are calculated from the service start date stored in the personnel information DB 260. The design review device 500 may use the training history or the skill information as a criterion for displaying either the review sheet A or the review sheet B.

The design review device 500 determines a product to be reviewed based on information representing a facility to which each reviewer belongs, selects candidates of relevant product models and review sheets, and displays the selected candidates on the HMD 340. The reviewer selects a product model and a review sheet from the displayed candidates. The information representing the facility and the product are associated with each other by matching the information representing the facility in the personnel information DB 260 with the information representing the product in the facility information DB 270. The design review device 500 calls a product model to be reviewed by the reviewer from the product model DB 210, a 3D model of a component included in the product from the component model DB 240, a 3D model of a tool used in assembling the product from the tool model DB 220, and a review sheet from the review sheet DB 230, and displays the obtained data on the HMD 340.

The customer spec information DB 280 and the review sheet DB 230 are associated with each other. The customer specifications are displayed on the HMD 340 as reference information every time a review sheet is displayed. The customer spec information DB 280 and the review sheet DB 230 are associated with each other based on the customer ID.

The design review device 500 with the above structure may display a review sheet in accordance with the learning level of a reviewer. Further, the design review device 500 determines a product to be reviewed by a reviewer, selects candidates of relevant product models and review sheets, and displays the selected candidates on the HMD 340. This structure allows the reviewer to easily call the product model and the review sheet.

Modifications

In the embodiments described above, the design review devices 100 and 500 each include the glove-shaped capture device 310 to capture the motions of the user's hand and digits. The design review devices 100 and 500 may include a full-body capture device for capturing the full-body motion of the user. In this case, the design review devices 100 and 500 use a tool 350 associated with a target to capture the full-body motion of the user in the actual assembly work or installation work. Based on the captured full-body motion, the presence of interference, the length of interference, and the history of interference check results for interfering components are stored into a review sheet. The structure of a component without interference is then determined based on computation using the interference check results, and candidates are displayed in a scrollable manner. A candidate is selected by the user's gesture and the selected result is stored into the component model DB 240.

The design review devices 100 and 500 including the full-body capture device may obtain log data about the motion trajectory of the user's hand or foot and a tool, and may apply the log data to review sheets. For example, the user may hold a tool in the virtual space in design review and actually attempt to tighten a bolt but cannot tighten the bolt due to interference between the tool and the product. In this case, the corresponding check item in the review sheet is marked as a failure. The log data for such check results may be used for evaluation items or check items for prototype design.

The design review devices 100 and 500 may also record an example work procedure and the motions of hands or feet performed by a skilled reviewer wearing the full-body capture device in animation. Further, notes and comments from work may be recorded on a 3D model of a product or a component with the stylus capture device 330 for use as an instruction brief. The work know-how and notes to be shared among reviewers may also be written on a 3D model of a product or a component. Additionally, the work procedure and the motions of hands or feet of unexperienced reviewers may be measured and used to visualize differences between skilled reviewers and unexperienced reviewers and use such information for education. For example, differences between skilled reviewers and unexperienced reviewers in, for example, the assembly order for each component, work posture, and eye lines during work may be displayed.

In the embodiments described above, the data server 200 may be accessible from a main facility and sub-facilities inside and outside Japan through the Internet connection. In this case, when the design review devices 100 and 500 including the communicator 300 that may access the data server 200, the glove-shaped capture device 310, the imaging device 320, the stylus capture device 330, the HMD 340, and the controller 400 are installed in the main facility and a sub-facility, design review can be performed in the main facility and the sub-facility and data stored in the data server 200 may be managed centrally. This allows review results to be updated in real time and shared between the main facility and the sub-facility. For example, when size information about a component is changed, the 3D CAD data is changed and stored in the product model DB 210 in real time. Further, the design review devices 100 and 500 may access design review devices 100 and 500 installed in other facilities including facilities located overseas through the Internet connection to share screens displaying 3D models in the virtual space and to perform design review together with the design review devices 100 and 500 installed in other facilities. This allows design review to be performed in real time at multiple facilities in collaboration with one another. Thus, when understanding the regulations or trends at an overseas sub-facility may be difficult at the main facility, design review may be performed at the sub-facility. Additionally, staff at an overseas facility and overseas customers may perform design review together efficiently to check detailed specifications for each customer. The design review devices 100 and 500 according to the present embodiment perform design review for products including elevators to facilitate the sale of the products worldwide.

The product specifications vary as the trends and preferences vary depending on countries in the world. The design review performed at multiple facilities and real-time update of the review results allow the creation of global design. For example, a country in which design review has been performed can be identified from handwriting written with the stylus capture device 330 and candidate components suitable for the country can be displayed in the virtual space. This allows products to have global design in real time. Further, a sub-screen may display a configuration tree representing the component configuration of a displayed component. The tree configuration of each component is called from the design information DB stored in the data server 200 and then displayed.

When a review result indicates that the specifications of a component are to be changed, candidates for alternative components are retrieved from the component model DB 240 based on the review result, and displayed. For example, when a review result indicates that a component A and a component B interfere with each other by 5 mm, a component having the same specifications as the component A but smaller by 5 mm is retrieved from the component model DB 240, and is then displayed in the virtual space as a candidate for an alternative component. Further, the data server 200 may include a purchase information DB storing component names, component specifications, component prices, and delivery dates in a manner associated with one another. The candidates for alternative components contained in the purchase information DB may then be displayed. Such alternative components may be displayed in the order of lower prices or in the order of shorter delivery periods.

Although the HMD 340 is non-transmissive in the embodiments described above, the HMD 340 may be semi-transmissive. In this case, a 3D model of a tool is superimposed on the tool placed in the real space. A review sheet is superimposed on the reference board 332. Further, although the HMD 340 displays the virtual space in the example described above, any display other than the HMD 340 may be used when the display can display a virtual space. A liquid crystal display may be used instead of the HMD 340.

Although the glove-shaped capture device 310 is used to detect the user's gesture representing the user action in the embodiments described above, other means may be used to detect the user's gestures. An imaging device may capture an image of the motion of the user's hand and digits, and may detect a gesture based on the captured image. The user actions include the body motion and the voice of the user, including the motion of the head, an arm, or a foot and the voice.

Although the stylus capture device 330 includes a sensor in the embodiments described above, the reference board 332 may include a touchscreen sensor and use the touchscreen sensor to detect handwriting on the reference board 332 written with a stylus including no sensor.

The design review process to be performed by the design review devices 100 and 500 and the data server 200 may be implemented by a device other than a dedicated system, and may be implemented by, for example, a general-purpose mobile information terminal or a personal computer. Programs used by the design review devices 100 and 500 and the data server 200 may be stored in a computer-readable recording medium, such as compact disc read only memory (CD-ROM), a digital versatile disc (DVD), a USB flash drive, a memory card, and a hard disk drive (HDD), and may then be distributed. When such programs are installed in a dedicated or general-purpose computer, the computer may then function as the design review devices 100 and 500 or the data server 200.

The programs described above may be stored in a storage device in another server on the Internet and may then be downloaded from the server.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

This application claims the benefit of Japanese Patent Application No. 2017-103675, filed on May 25, 2017, the entire disclosure of which is incorporated by reference herein.

### REFERENCE SIGNS LIST

100, 500 Design review device
200 Data server
210 Product model DB
220 Tool model DB
230 Review sheet DB
240 Component model DB
250 Review model DB
260 Personnel information DB
270 Facility information DB
280 Customer spec information DB
300 Communicator
310 Glove-shaped capture device
320 Imaging device
330 Stylus capture device
331 Acceleration sensor
332 Reference board
333 Pressing force sensor
340 HMD
350 Spanner
351 Target reference marker
400 Controller
410 Gesture capturer
420 Tool capturer
430 Handwriting capturer
440 Display controller
450 Menu controller
460 Model operator
470 Review recorder
W1 Wall panel
F1 Floorboard
B1 Bolt
S1 Spanner
C1 Recess
J1 Holding jig
H1 Threaded hole

1. A design review device comprising:
a communicator to access a data server storing data for a 3D model of a component included in a product, data for a 3D model of a tool to be used in assembling the product, and data for a review sheet including a design review result for the product;
a display controller to display in a virtual space a screen for selecting at least one of the 3D model of the component or the 3D model of the tool; and
a capturer to detect a user action and select, in response to the user action, the at least one of the 3D model of the component or the 3D model of the tool displayed in the virtual space,
wherein the display controller displays a format of the review sheet in the virtual space, and
the capturer detects a writing motion of a stylus on the review sheet and stores data representing the written review result into the review sheet in response to the writing motion of the stylus.

2. The design review device according to claim 1, further comprising:
a model operator to display in the virtual space the at least one of the 3D model of the component or the 3D model of the tool selected by the capturer, detect a user action of moving and rotating the at least one of the 3D model of the component or the 3D model of the tool detected by the capturer and displayed in the virtual space, and move or rotate, in response to the user action, the at least one of the 3D model of the component or the 3D model of the tool displayed in the virtual space within a range of no mutual contact.

3. The design review device according to claim 1, wherein
the display controller displays the at least one of the 3D model of the component or the 3D model of the tool in the virtual space in a scrollable manner, and
the capturer detects a user action and scrolls, in response to the user action, the at least one of the 3D model of the component or the 3D model of the tool displayed in the virtual space to select the at least one of the 3D model of the component as a target or the 3D model of the tool as a target.

4. The design review device according to claim 1, wherein
the display controller displays a format of the review sheet in the virtual space, and
the capturer detects a writing motion of a stylus on the review sheet, captures handwriting in response to the writing motion of the stylus, converts data for the handwriting to text data, and stores the text data into the review sheet.

5. The design review device according to claim 4, wherein
the capturer detects a language for the handwriting and stores the language for the handwriting into the review sheet.

6. The design review device according to claim 1, further comprising:
a head mount display to display the virtual space in accordance with a position and an orientation of a head of the user,
wherein the display controller displays on the head mount display at least one of the 3D model of the component, the 3D model of the tool, or the format of the review sheet.

7. The design review device according to claim 1, wherein
the capturer detects a position and an orientation of the tool placed in a real space, and the display controller displays the 3D model of the tool in a manner superimposed on the tool detected by the capturer.

8. A design review method comprising:
a communication step of accessing a data server storing data for a 3D model of a component included in a product, data for a 3D model of a tool to be used in assembling the product, and data for a review sheet including a design review result for the product;
a displaying step of displaying in a virtual space a screen for selecting at least one of the 3D model of the component or the 3D model of the tool; and
a capturing step of detecting a user action and selecting, in response to the user action, the at least one of the 3D model of the component or the 3D model of the tool displayed in the virtual space, and
wherein the design review method further includes:
in the displaying step, displaying a format of the review sheet in the virtual space, and
in the capturing step, detecting a writing motion of a stylus on the review sheet and storing data representing the written review result into the review sheet in response to the writing motion of the stylus.

9. The design review method according to claim 8, wherein
the communication step includes accessing a design review device installed in another facility and performing the design review in collaboration with the design review device installed in the another facility.

10. (canceled)

11. A non-transitory computer-readable recording medium storing a program for causing a computer including a communicator to access a data server storing data for a 3D model of a component included in a product, data for a 3D model of a tool to be used in assembling the product, and data for a review sheet including a design review result for the product, to function as:
a display controller to display in a virtual space a screen for selecting at least one of the 3D model of the component or the 3D model of the tool; and
a capturer to detect a user action and select, in response to the user action, the at least one of the 3D model of the component or the 3D model of the tool displayed in the virtual space, and
wherein the display controller displays a format of the review sheet in the virtual space, and
the capturer detects a writing motion of a stylus on the review sheet and stores data representing the written review result into the review sheet in response to the writing motion of the stylus.
